(19) United States
(12) Patent Application Publication
(10) Pub. No.: US 2002/0080805 A1
(43) Pub. Date: Jun. 27, 2002

(54) Method for establishing a telecommunications connection and service units and programme modules therefore

(75) Inventors: Yuzhong Shen, Stuttgart (DE); Thomas Ryll, Berlin (DE); Uwe Lauff, Rutesheim (DE); Ralph Gutmann, Ditzingen (DE); Jens Bohrer, Stuttgart (DE)

Correspondence Address: SUGHRUE, MION, ZINN, MACPEAK & SEAS, PLLC, 2100 Pennsylvania Avenue, N.W., Washington, DC, 20037-3213, US

(73) Assignee: ALCATEL

(21) Appl. No.: 10/012,402

(22) Filed: Dec. 12, 2001

(30) Foreign Application Priority Data
Dec. 23, 2000 (DE) 10064999.8

(51) Int. Cl. H04L 12/28

(52) U.S. Cl. 370/401; 370/352

(57) ABSTRACT

The invention relates to a method of establishing a telecommunications connection between a first subscriber (SA) and a second subscriber (SB) of a telecommunications network (TN), wherein at least the first subscriber (SA) has an Internet terminal (ITA), wherein the first subscriber (SA) sends an information from his Internet terminal (ITA) to a first service unit (WS) for carrying out services for Internet users with a request to the connected to the second subscriber (SB), the first service unit (WS) sends a message to a second service unit (SCP) for carrying out services in a telecommunications network (TN) which contains the call numbers of the above-mentioned subscribers (SA, SB) and the command to establish a (telecommunications) connection between the above-mentioned subscribers (SA, SB) and the second service unit (SCP) establishes a connection between the two above-mentioned subscribers (SA, SB) in the telecommunications network (TN),and further relates to a service unit (WS) for carrying out services for Internet users, to a service unit (SCP) for carrying out services in a telecommunications network (TN) and to program modules for the sequence in said service units.

### BACKGROUND OF THE INVENTION

The invention is based on a priority application DE 100 64 999.8, which is hereby incorporated by reference.

The invention relates to a method for establishing a telecommunications connection between a first subscriber and a second subscriber of a telecommunications network, wherein at least the first subscriber has an Internet terminal, to a service unit for carrying out services for Internet users and to a service unit for carrying out services in a telecommunications network, and to programme modules for this purpose.

A (telephone) subscriber can use a traditional telephone information service to search for the call number of a further subscriber. For this purpose he initially has to dial the call number of the information service. He is then connected, generally after a wait, to an employee of the information service. He then communicates to the employee certain criteria—at least the surname and the town—to identify the subscriber. The employee then enters these search criteria into a computer. The subscriber has to provide additional or amended criteria as and when the employee requests it until the subscriber sought can be identified. The call number(s) of the subscriber found is (are) then communicated verbally to the searching subscriber, frequently automatically by means of a device with means for voice synthesis.

A further internally proposed service for call number searching in which, in addition, the establishment of a (telecommunications or telephone) connection which automatically follows a search is offered may be achieved by a so-called intelligent network (IN) superimposed on the telephone network. To activate the aforementioned service a service unit of the intelligent network (IN) which comprises means for voice analysis is called up. As in the telephone information service described at the outset, a dialog takes place between this service unit and the calling subscriber until the subscriber sought can be identified. The corresponding establishment of a connection can then be initiated, if desired, automatically in that the call numbers of the searching subscriber and of the sought subscriber are passed to a network device of the telephone network in order to establish a connection. A drawback of this service is the verbal communication between man and machine which is negatively regarded by many subscribers owing to the obviously limited flexibility of the dialog. In addition, depending on the pronunciation or dialect of the subscriber problems of understanding or misunderstandings can occur in the voice analysis, in particular if the pronunciation of the name of the subscriber sought is not precisely known and/or is difficult.

Certain Internet services provide further services according to the state of the art for straightforward ascertainment of call numbers, wherein a subscriber calls up an Internet page of an appropriate Internet server or Internet service unit by means of an Internet terminal, inputs certain criteria of the subscriber sought, for example surname and town, in certain fields of this Internet site and sends this information, for example by selecting a certain button, back to the telephone information computer. As an answer he then receives an Internet page with a list of subscribers, each with address information and call number(s) which meet the criteria provided. If the subscriber sought is on the list the searcher can find the, or one of the, call number(s). If the subscriber sought is not on the list or the list is too extensive the Internet subscriber can modify the aforementioned criteria and retransmit it to the Internet service unit in order to obtain a new list.

Misunderstandings can be virtually ruled out owing to the possibility of providing detailed search results on an Internet page. In addition, a search may be initiated even with initially approximate or unclear criteria which are then repeatedly refined or made more concrete, with appropriately rendered search language. However, a potentially subsequently desired connection in the telephone network has to be established by a manual and therefore inconvenient and error-prone inputting of the call number found into a telephone terminal.

### SUMMARY OF THE INVENTION

It is an object of the invention to further improve the last-described method of call number searching by means of the Internet.

The basic idea of the invention is to connect the Internet to the telephone network so the identification of a subscriber sought, the ascertainment of his call number and the authorisation to produce a connection by the searching subscriber are made exclusively on the Internet, i.e. by means of an Internet service unit and an Internet terminal of the searching subscriber. The request from the Internet service unit is then passed to a control computer of the telephone network which establishes and monitors connection in the telephone network.

Further advantageous configurations of the invention can be inferred from the dependent claims and the description.

### BRIEF DESCRIPTION OF THE DRAWINGS

The invention will be described hereinafter with the aid of the drawings, in which:

FIG. 1 shows schematically a communications network consisting of the Internet and a telephone network, with service units according to the invention,

FIG. 2 shows schematically a communications network with a device for Internet telephony,

FIG. 3 shows, by way of example, a flow chart of a method according to the invention.

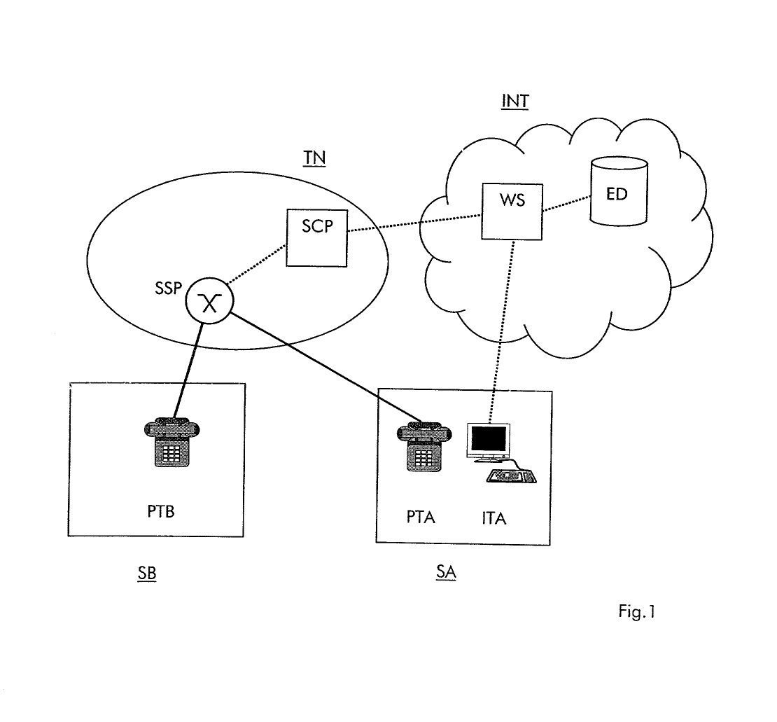

FIG. 1 shows the Internet INT with a first service unit WS and a database ED, a line switching (telephone) network TN with a second Internet service unit SCP and a switching point SSP, a first subscriber SA with an Internet terminal ITA and a first telephone terminal PTA and a second subscriber SB with a second telephone terminal PTB. The first Internet terminal ITA is connected to the first service unit WS, the first service unit WS is connected to the database ED and the second service unit SCP respectively and the second service unit SCP is also connected to the switching point SSP. The described connections shown by broken lines represent data or signalling connections. A communications or voice connection between the first telephone terminal PTA via the switching point SSP and the second telephone terminal PTB are also shown, by solid lines.

The first service unit WS is a so-called Internet server or WWW (worldwide web) server which communicates by means of the so-called Internet protocol, hereinafter called IP protocol, with further Internet servers or Internet terminals connected to the Internet. A PC (personal computer) with certain programme means, also called WWW browsers, which is connected via a modem or a local network to an Internet access server generally serves as Internet terminal ITA. To call up an Internet page or web page of the first service unit WS the Internet terminal ITA transmits, after activating the connection to the Internet, often called logging-on for short, a clear address which identifies this Internet page, also called “unified resource location” (URL), or a name clearly connected therewith. An Internet page can contain static and/or dynamic information, wherein the dynamic information can, for example, be dependent on information transmitted beforehand by the subscriber SA. It can also serve as a so-called input mask which comprises certain input fields which the subscriber can fill with text. The input information (not the entire Internet page) is transmitted back to the first service unit WS by acknowledgement, for example by actuating the “return key” or by selecting or clicking a screen button provided for this purpose.

The second service unit SCP is a control computer for the telephone network, for example a so-called service control point of a so-called intelligent network superimposed on the telephone network. The intelligent network allows socalled IN services which go beyond pure call switching to be provided. The switching point SSP here is a switching point of the telephone network TN which is expanded by interface functions to communicate with the service unit SCP by means of so-called INAP messages (intelligent network application protocol).

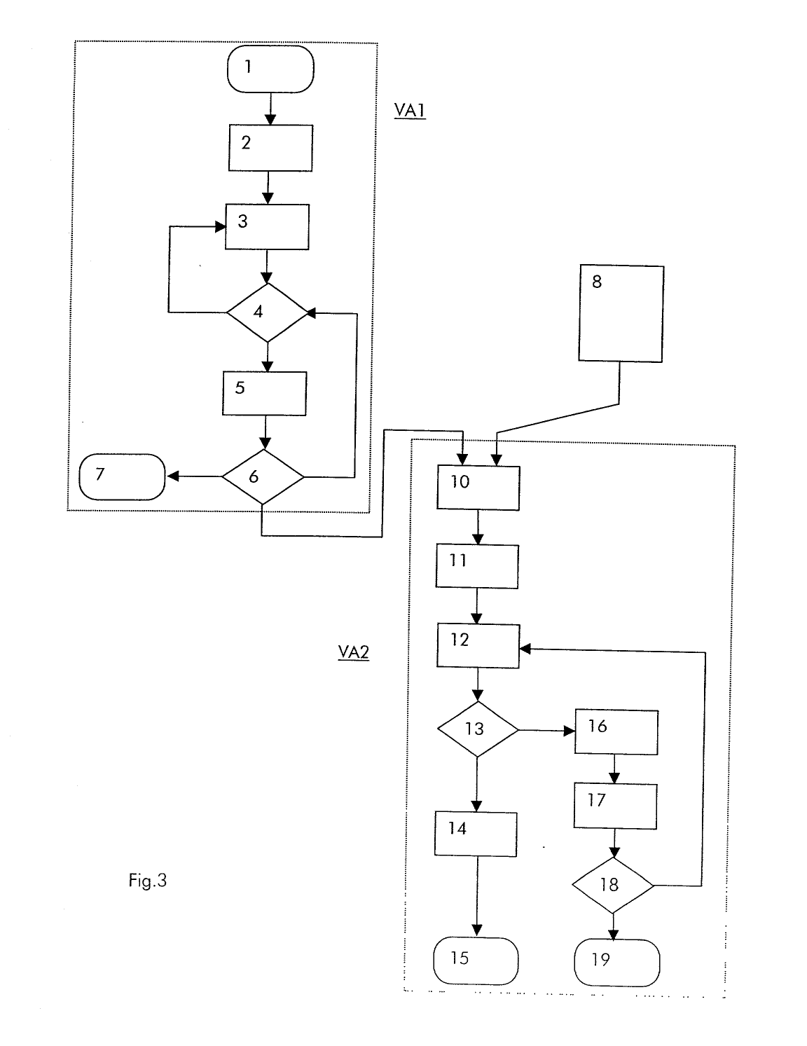

The first service unit WS serves in a first stage of a method according to the invention for carrying out a service to search for the call number with subsequent automatic establishment of a connection. In conjunction with the first service unit WS and the first subscriber SA a first unknown call number of a second subscriber SB is ascertained, the first service unit WS optionally referring to data stored in the database ED. As this communication is conducted between the first service unit WS and the first subscriber SA by means of Internet pages, the method to search for call numbers can be configured most conveniently. Therefore the first subscriber SA can begin even with very unclear criteria, for example with an incomplete name of a subscriber sought, and can improve the search result iteratively, in other words by repeated exchange of information with the first service unit WS, until a sought subscriber is identified and his call number(s) thus found. This first stage of the method does not in principle differ from a method of searching the Internet described at the outset by means of search devices which are provided, for example, by large telecommunications providers. The difference from known methods is that after the first stage of the method has taken place, in other words after successful discovery of a call number, if the first subscriber SA desires, a connection is automatically established between the first telephone terminal PTA of this subscriber SA and the second telephone terminal PTB of the (sought) second subscriber SB in a second stage of the method. To this end the Internet INT and the telephone network TN are connected to one another in that a connection is provided between the first service unit WS and the second service unit SCP. This connection allows the service units WS and SCP to coordinate control of the above-mentioned service. A detailed sequence of a method according to the invention is described by way of example with respect to FIG. 3.

The functions of the first service unit WS and/or the second service unit SCP can, for example in a large national telephone network, each be distributed physically among a plurality of computers of a computer network. The above-mentioned functions of the service units WS and SCP can, for example in a small local telephone network, also be integrated physically in one computer which then has both a signalling interface to devices of the telephone network TN, in particular the switching point SSP, and an Internet interface.

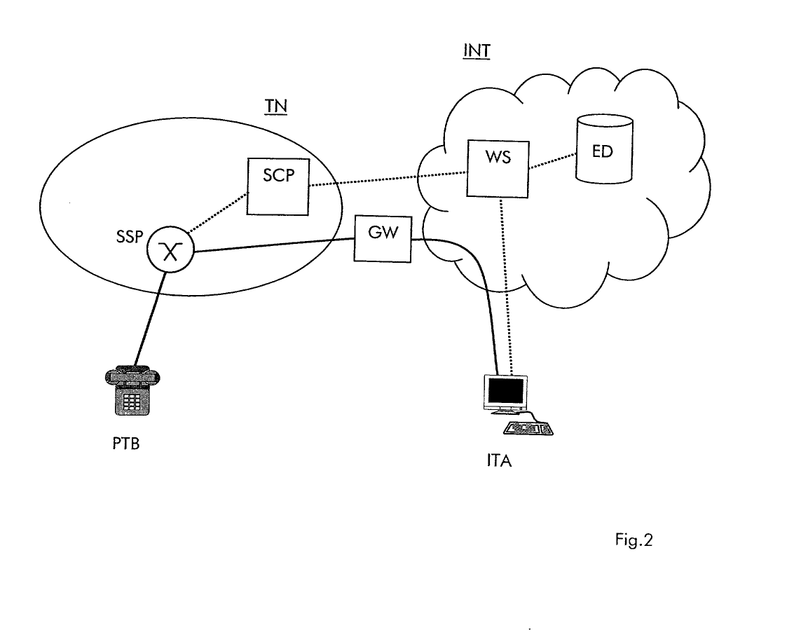

FIG. 2 differs from FIG. 1 in that the first subscriber SA has only an Internet terminal ITA with voice input and output. In addition, a speech gateway or voice gateway GW is shown. Instead of the connection between the first telephone terminal PTA via the switching point SSP and the second telephone terminal PTB shown in FIG. 1, here a connection is shown between the first telephone terminal PTA via the switching point SSP, the voice gateway GW, and the Internet terminal ITA of the first subscriber SA.

The voice gateway serves to convert protocol from the protocol of the telephone network TN to the Internet protocol INT and vice versa. Therefore, the so-called IP data packets produced by the first Internet terminal ITA are converted, by way of example, into ATM data packets of the telephone network TN and vice versa. A voice gateway is specified, for example, in the document “draft recommendation G.799.1” of the International Telecommunication Union, Sector Telecom (ITU-T).

Here the Internet terminal ITA serves, in addition to its function as dialog device with the first service unit WS, as terminal for the telephone network TN. To this end there is a conversion of the voice signals from the first subscriber SA into suitable IP data packets and vice versa a conversion of IP data packets into analogue voice signals, for example by means of a functional expansion of the browser described at the outset, which voice signals are emitted by a loud speaker on the Internet terminal ITA. For the event that the subscriber can maintain two connections simultaneously with his Internet terminal ITA, for example by means of an ISDN connection, one of the connections can be reserved for voice communication. For the event that only one connection can be established voice information from the first subscriber SA is received upon depression of a key or after selecting a screen button, converted into IP data packets and transmitted to the voice gateway. Such techniques are known from the state of the art and are increasingly used. The document (ITU-T Recommendation H.323) from the International Telecommunication Union describes a packet data communication system designed for voice transmission with its components and in particular the terminals of a communication system of this type.

FIG. 3 shows by way of example a sequence of a method according to the invention for establishing a (telecommunications) connection between the first subscriber SA and the second subscriber SB in essential functional or sequence steps 1 to 19. The individual (functional) steps each represent an individual function or a group of logically coherent functions. Here the rounded rectangles 1, 7, 15 and 19 symbolise steps with which the service described is started or terminated. The rhombuses 4, 6, 13 and 18 shown symbolise steps according to which the various steps are branched depending on the processing result. The rectangles 2, 3, 5, 8, 10, 11, 12, 14, 16 and 17 shown symbolise steps after the processing of which a clear next step follows without branching. The steps 1 to 7 constitute a first stage VA1 of the method according to the invention. Here the first service unit WS and the first subscriber SA communicate to search for a call number of a second subscriber SB. The steps 10 to 19 constitute the sequence of a second stage VA2 of the method according to the invention. This method stage VA2 serves to automatically establish a connection between the first subscriber SA and the subscriber SB, whose call number was ascertained in the first method stage VA1. This second method stage VA2 can be started directly, without running through the first method stage VA1 first, by inputting the call number. The individual steps will be described in detail hereinafter. To simplify the description, the subscribers SA and SB with their terminals PTA and ITA or PTB are equated. In particular, it does not matter whether the first subscriber is connected via an Internet terminal ITA or via a telephone terminal PTA to the second subscriber SB:

In step 1 the first subscriber SA starts the sequence of the above-mentioned method in that he requests an Internet page from the first service unit WS.

In the next step 2 the first service unit WS sends the requested Internet page to the first subscriber SA.

In the next step 3 the first subscriber SA processes this Internet page by inputting search criteria or optionally by modifying search criteria already input and transmits this criteria by acknowledgement, i.e. as described above by selecting or clicking on a screen button provided for acknowledgement (for example a button with the word “OK”), back to the first service unit WS.

In the next step 4 the first service unit WS checks the criteria received for formal correctness, for example whether certain obligatory fields have been filled in. In the event of a negative test result it generates an Internet page which contains an error message appropriate to the test result and a prompt to input new search criteria or to modify the search criteria input in step 3. Upon transmission of this page to the first subscriber SA branching back to step 3 then ensues. In the event of a positive test result the first service unit WS, optionally in conjunction with the database ED shown in FIG. 1, identifies a results list which contains subscribers to which the criteria provided apply and transmits an Internet page containing this results list to the first subscriber SA.

In the next step 5 the first subscriber SA processes this Internet page in that he selects a second subscriber SB from the results list, for example by marking an appropriate screen field. By acknowledgement, for example by clicking on a button “click-to-dial” he transmits to the first service unit WS a corresponding desire to be connected to the selected second subscriber SB. Alternatively, he transmits new or modified search criteria or the desire to end the method sequence.

In the next step 6 the first service unit WS branches to steps 4, 7 or 10, depending on the information communicated. If this information contains the wish to terminate, then branching proceeds to step 7. If this information contains new or modified search criteria, then branching returns to step 4 to check this criteria. If this information contains a desire for connection to the second subscriber SB, then branching proceeds to step 10 to start the second method stage VA2.

The described method is terminated with step 7. The first service unit WS then optionally generates an Internet page with corresponding information and transmits this Internet page to the first subscriber SA.

Step 8 constitutes an alternative step to the described steps 1 to 7, which also leads to step 10. In this step 8 the first subscriber SA can transmit a desire for connection directly, for example in that he clicks on a button of an Internet site with which a permanently programmed call number of a subscriber SB is transmitted to the first service unit WS.

In step 10, to ascertain the call number of the first subscriber SA the first service unit WS transmits a further Internet page to this subscriber SA. This Internet page contains, for example, the text “please enter your full call number in the field highlighted”, and a field for inputting the telephone number.

In the next step 11 the first subscriber SA transmits his telephone number to the first service unit WS by acknowledgement. If the subscriber SA has an Internet terminal ITA with voice input and output then instead of the call number he transmits his Internet address and the corresponding gateway address. In an alternative variation to steps 10 and 11 the first service unit WS ascertains the call number or the Internet and gateway address of the first subscriber SA from a database ED in which call numbers are connected with IP addresses. The steps 10 and 11 can alternatively also be executed in the first method stage VA1.

In the next step 12 the first service unit WS transmits a prompt to produce the connection together with the call numbers of the first subscriber SA and the second subscriber SB to the second service unit SCP.

In the next step 13 it is ascertained in conjunction with the switching point SSP and the second service unit SCP whether a connection can be produced. In the event that a connection can be produced branching proceeds to step 14. In the event that a connection cannot be produced, for example because the telephone terminal PTB of the second subscriber SB is engaged, branching proceeds to step 16 in that the second service unit SCP transmits a corresponding message to the first service unit WS.

In step 14 the connection between the first subscriber SA and the second subscriber SB is established.

In the next step 15 the above-described method sequence is terminated. The second service unit SCP optionally informs the first service unit WS about the successful establishment of a connection which in turn then generates a corresponding Internet page and communicates this Internet page to the first subscriber SA.

In step 16 the first service unit WS informs the first subscriber SA by means of an Internet page that a connection could not be established and prompts him by means of this Internet page to choose between terminating the method sequence and a renewed attempt at establishing a connection, after a time set by the first subscriber SA or fixed in advance.

In the next step 17 the first subscriber SA processes the Internet page transmitted, for example by selecting appropriate buttons. He then transmits this information by acknowledgement to the first service unit WS.

In the next step 18 in the event that a renewed attempt at establishing a connection is desired the first service unit WS transmits a corresponding prompt again together with the call numbers of both subscribers to the second service unit SCP and therefore branches back to step 12. In the event that termination of the method sequence is desired branching proceeds to step 19.

With step 19 the above-described method sequence is terminated. The first service unit WS then optionally generates an Internet page with corresponding information and transmits this Internet page to the first subscriber SA.

In an expansion of the method according to the invention the first subscriber is given the option of inputting in step 5 a desire to connect to a plurality of subscribers simultaneously.

In a further advantageous expansion information is stored in the data base ED for registered subscribers which details whether the corresponding subscriber wants to partially or completely absorb the resulting call charges.

In the usual case, for which no information has to be stored, the subscriber making the call absorbs the charges. The first service unit WS informs the second service unit SCP, in conjunction with the transmission of the call numbers, how the charges are to be made. The second service unit SCP makes a corresponding charge in the telephone network TN. This is advantageous, for example for companies which wish, on principle, to absorb the call charges, for example for consultation charges. It is also conceivable that a registered subscriber will not, on principle, want to absorb all charges but, for example, only charges for national calls or for calls which are made at specific times of the day. The corresponding information is also stored in the database.

1. Method of establishing a telecommunications connection between a first subscriber and a second subscriber of a telecommunications network, wherein at least the first subscriber has an Internet terminal, with the following steps:
the first subscriber sends an information from his Internet terminal to a first service unit for carrying out services for Internet users with a request to be connected to the second subscriber,
the first service unit sends a message to a second service unit for carrying out services in a telecommunications network which contains the call numbers of the above-mentioned subscribers and a command to establish a (telecommunications) connection between the above-mentioned subscribers and
the second service unit establishes a connection between the two above-mentioned subscribers in the telecommunications network.

2. Method according to claim 1, wherein the call number of the second subscriber is ascertained by the following steps:
the first subscriber calls up an Internet page of the first service unit to input search criteria in input fields provided for this purpose,
the first subscriber inputs search criteria for the second subscriber sought and transmits these criteria by acknowledgement and
the first service unit identifies the second subscriber and ascertains a call number for the second subscriber.

3. Method according to claim 1, wherein the first service unit receives the call number of the first subscriber via a query to this subscriber by means of an Internet page.

4. Method according to claim 1, wherein the first service unit receives the call number of the first subscriber via a query to an Internet device.

5. Method according to claim 1, wherein the connection between the subscribers is established via the Internet terminal of the first subscriber, the call data being conducted via a voice gateway between the telephone network and the Internet for protocol conversion.

6. Method according to claim 1, wherein if the desired connection cannot be established, for example because the telephone terminal of the second subscriber is engaged, the second service unit transmits information to this effect to the first subscriber via the first service unit.

7. Method according to claim 1, wherein flexible charging for the telephone connections is effected in that the first service control provider communicates to the second service unit which proportions of the charges due should be charged to the first subscriber and/or the second subscriber.

8. Service unit for carrying out services for Internet users, with means for carrying out the following steps:
ascertaining the call number of a first subscriber,
ascertaining the call number of a second subscriber and
sending a message to a second service unit for carrying out services in a telecommunications network which contains the call numbers of the above-mentioned subscribers and a command to establish a connection between the above-mentioned subscribers.

9. Service unit according to claim 8, wherein it contains receiving means to receive a call number transmitted by the first subscriber for the purpose of ascertaining the call number of the second subscriber.

10. Service unit according to claim 8, wherein for ascertaining the call number of the second subscriber it contains further means for carrying out the following steps:
sending an Internet page for inputting search criteria in input fields provided for this purpose,
receiving the search criteria and
identifying the second subscriber with the aid of the search criteria and ascertaining a call number of the second subscriber.

11. Service unit for carrying out services in a telecommunications network, with means for carrying out the following steps:
receiving a message from a first service unit for carrying out services for Internet users, which contains the call numbers of subscribers and the request to establish a connection between the above-mentioned subscribers and
communication with further devices of the telecommunications network for controlling the establishment of a connection between the above-mentioned subscribers.

12. Programme module for use in a service unit for carrying out services for Internet users with programme means for controlling the following steps:
ascertaining the call number of a first subscriber,
ascertaining the call number of a second subscriber and
sending a message to a second service unit for carrying out services in a telecommunications network, which contains the call numbers of the above-mentioned subscribers and a command to establish a connection between the above-mentioned subscribers.

13. Programme module for use in a service unit for carrying out services in a telecommunications network with programme means for controlling the following steps:
receiving a message from a first service unit for carrying out services for Internet users which contains the call numbers of subscribers and a request to establish a connection between the above-mentioned subscribers and
communication with further devices of the telecommunications network to control the establishment of a connection between the above-mentioned subscribers.
